(19) United States
(12) Patent Application Publication
(10) Pub. No.: US 2026/0303503 A1
(43) Pub. Date: Oct. 1, 2026

(54) PERFORMANCE TESTING USING ASYMMETRIC SYNTHETIC TRAFFIC

(71) Applicant: Telefonaktiebolaget LM Ericsson (publ), Stockholm (SE)

(72) Inventor: Gregory MIRSKY, Pleasanton, CA (US)

(73) Assignee: Telefonaktiebolaget LM Ericsson (publ), Stockholm (SE)

(21) Appl. No.: 19/481,009

(22) PCT Filed: Jun. 2, 2023
(86) PCT No.: PCT/IB2023/055716

§ 371 Date: Nov. 3, 2025

(51) Int. Cl. H04L 43/10; H04L 41/14; H04L 43/50

(52) U.S. Cl. CPC H04L 43/10; H04L 41/145; H04L 43/50

(57) ABSTRACT

A method performed by a network device functioning as a session-sender in a measurement session with a session-reflector to simulate asymmetric network traffic is disclosed. The method includes generating a test packet to send to the session-reflector, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The method further includes sending the test packet to the session-reflector to cause the session-reflector to generate and send the set of reflected test packets to the session-sender in accordance with the reflected test packet control information.

### TECHNICAL FIELD

Embodiments disclosed herein relate to the field of active measurement protocols, and more specifically, to simulating asymmetric network traffic during a measurement session of an active measurement protocol.

### BACKGROUND

Active measurement protocols (e.g., Simple Two-way Active Measurement Protocol (STAMP), as described in Request for Comment (RFC) 8762 or RFC 8972) generate synthetic network traffic to measure packet loss, measure packet delay, detect packet duplication, and/or detect out-ot-order delivery in a network.

With conventional active measurement protocols, a session-sender sends a test packet to a session-reflector. Responsive to receiving the test packet, the session-reflector sends a reflected test packet to the session-sender. The session-sender may measure the network performance based on the contents of the reflected test packet (e.g., a timestamp indicating when the session-reflector sent the reflected test packet) and/or other information related to the reflected test packet (e.g., the time at which the session-sender received the reflected test packet from the session-reflector).

With conventional active measurement protocols, each test packet sent by the session-sender to the session-reflector causes the session-reflector to send a single reflected test packet back to the session-sender. Also, the length of the reflected test packet sent by the session-sender is equal to the length of the test packet that is reflected by the session-sender. Thus, the network traffic generated by conventional active measurement protocols is symmetrical in terms of quantity (there is one reflected test packet per test packet) and length (the test packet and the corresponding reflected test packet have equal lengths). Conventional active measurement protocols may not be able to accurately simulate real network traffic behavior, which is often not symmetric by nature.

### SUMMARY

A method performed by a network device functioning as a session-sender in a measurement session with a session-reflector to simulate asymmetric network traffic is disclosed. The method includes generating a test packet to send to the session-reflector, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The method further includes sending the test packet to the session-reflector to cause the session-reflector to generate and send the set of reflected test packets to the session-sender in accordance with the reflected test packet control information.

A method performed by a network device functioning as a session-reflector in a measurement session with a session-sender to simulate asymmetric network traffic is disclosed. The method includes receiving a test packet from the session-sender, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The method further includes generating and sending the set of reflected test packets to the session-sender in accordance with the reflected test packet control information in response to receiving the test packet.

A non-transitory machine-readable storage medium is disclosed that provides instructions that, if executed by a processor of a network device functioning as a session-sender in a measurement session with a session-reflector, will cause said session-sender to perform operations for simulating asymmetric network traffic. The operations include generating a test packet to send to the session-reflector, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The operations further include sending the test packet to the session-reflector to cause the session-reflector to generate and send the set of reflected test packets to the session-sender in accordance with the reflected test packet control information.

A non-transitory machine-readable storage medium is disclosed that provides instructions that, if executed by a processor of a network device functioning as a session-reflector in a measurement session with a session-sender, will cause said session-reflector to perform operations for simulating asymmetric network traffic. The operations include receiving a test packet from the session-sender, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The operations further include generating and sending the set of reflected test packets to the session-sender in accordance with the reflected test packet control information in response to receiving the test packet.

A network device configured to function as a session-sender in a measurement session with a session-reflector is disclosed. The network device includes one or more processors and a non-transitory machine-readable storage medium that stores instructions, which when executed by the one or more processors, causes the session-sender to perform operations for simulating asymmetric network traffic. The operations include generating a test packet to send to the session-reflector, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The operations further include sending the test packet to the session-reflector to cause the session-reflector to generate and send the set of reflected test packets to the session-sender in accordance with the reflected test packet control information.

A network device configured to function as a session-reflector in a measurement session with a session-sender is disclosed. The network device includes one or more processors and a non-transitory machine-readable storage medium that stores instructions, which when executed by the one or more processors, causes the session-reflector to perform operations for simulating asymmetric network traffic. The operations include receiving a test packet from the session-sender, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The operations further include generating and sending the set of reflected test packets to the session-sender in accordance with the reflected test packet control information in response to receiving the test packet.

Embodiments can be used to more accurately simulate real network traffic behavior during a measurement session, which in turn allows for determining/calculating more relevant network performance measurements.

### BRIEF DESCRIPTION OF THE DRAWINGS

The invention may best be understood by referring to the following description and accompanying drawings that are used to illustrate embodiments. In the drawings:

FIG. 1 is a diagram showing an environment in which asymmetric network traffic can be generated during a measurement session between a session-sender and a session-reflector, according to some embodiments.

FIG. 2 is a diagram showing a test packet format with a reflected packet control TLV, according to some embodiments.

FIG. 3 is a diagram showing a reflected test packet control TLV field format, according to some embodiments.

FIG. 4 is a flow diagram of a process performed by a session-sender in a measurement session with a session-reflector for simulating asymmetric network traffic, according to some embodiments.

FIG. 5 is a flow diagram of a process performed by a session-reflector in a measurement session with a session-sender for simulating asymmetric network traffic, according to some embodiments.

FIG. 6A illustrates connectivity between network devices (NDs) within an exemplary network, as well as three exemplary implementations of the NDs, according to some embodiments.

FIG. 6B illustrates an exemplary way to implement a special-purpose network device, according to some embodiments.

### DETAILED DESCRIPTION

The following description describes methods and apparatus for simulating asymmetric network traffic during a measurement session of an active measurement protocol. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment o may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, the network traffic generated by conventional active measurement protocols (e.g., Simple Two-way Active Measurement Protocol (STAMP), as described in Request for Comment (RFC) 8762 or RFC 8972) is symmetrical in terms of quantity (there is one reflected test packet per test packet) and length (the test packet and the corresponding reflected test packet have equal lengths). However, real network traffic behavior is often asymmetrical, and conventional active measurement protocols are not able to accurately simulate asymmetrical network traffic.

Conventional active measurement protocols do not provide a mechanism to control the number or length of the reflected test packets that the session-reflector is to send to the session-sender in response to receiving a test packet from the session-sender. This limits the ability of conventional measurement protocols to accurately simulate real network traffic behavior, which as mentioned above, is often asymmetric by nature (e.g., a server generating multiple packets in response to a query or a larger packet being sent in response to a relatively smaller request).

Embodiments are disclosed herein that can generate asymmetric network traffic during a measurement session of an active measurement protocol. Embodiments achieve this by specifying information (also referred to herein as “reflected test packet control information”) in the test packet sent by the session-sender to the session-reflector that indicates the number of reflected test packets the session-reflector is to send to the session-sender, a time interval that the session-reflector is to use between consecutive reflected test packets, and/or the length of each reflected test packet. The session-sender may use the reflected test packet control information to control the behavior of the session-reflector in terms of how the session-reflector responds to the test packet. Embodiments provide fine-grained control over the behavior of the session-reflector, which allows for better simulating real network traffic behavior.

In an embodiment, the test packet includes a special type-length-value (TLV) field (also referred to herein as a “reflected packet control TLV” field) that includes the reflected test packet control information. The reflected packet control TLV field may use the TLV mechanism described in RFC 8972 or a similar mechanism, so as to conform to existing protocol extension mechanism (e.g., which may allow for better interoperability and backwards compatibility).

An example embodiment is a method performed by a network device functioning as a session-sender in a measurement session with a session-reflector to simulate asymmetric network traffic. The method includes generating a test packet to send to the session-reflector, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The method further includes sending the test packet to the session-reflector to cause the session-reflector to generate and send the set of reflected test packets to the session-sender in accordance with the reflected test packet control information.

Another example embodiment is a method performed by a network device functioning as a session-reflector in a measurement session with a session-sender to simulate asymmetric network traffic. The method includes receiving a test packet from the session-sender, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet. The method further includes generating and sending the set of reflected test packets to the session-sender in accordance with the reflected test packet control information in response to receiving the test packet. Embodiments will now be described with reference to the accompanying figures.

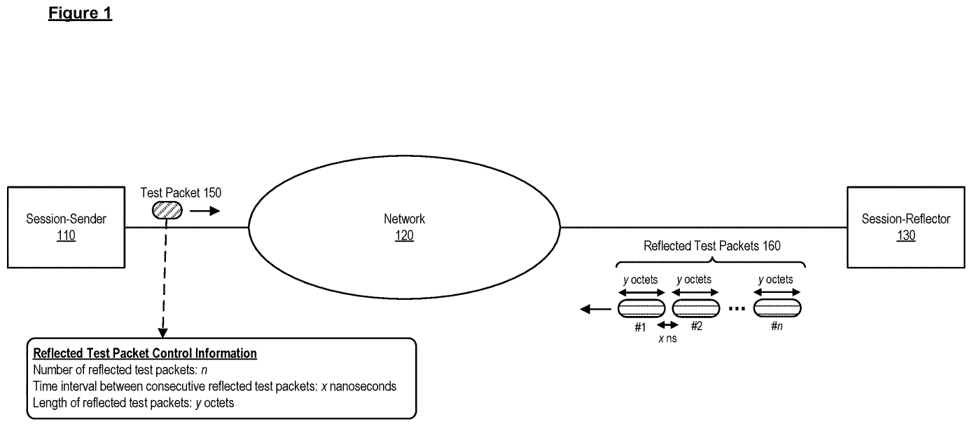

FIG. 1 is a diagram showing an environment in which asymmetric network traffic can be generated during a measurement session between a session-sender and a session-reflector, according to some embodiments. As shown in the diagram, the environment includes a session-sender 110, a network 120, and a session-reflector 130. The session-sender 110 and the session-reflector may 130 communicate with each other over the network 120. The session-sender 110 and the session-reflector 130 may each be implemented by a network device. The network 120 may comprise one or more backhaul networks, core networks, Internet Protocol (IP) networks, public switched telephone networks (PSTNs), packet data networks, optical networks, wide-area networks (WANs), local area networks (LANs), wireless local area networks (WLANs), wired networks, wireless networks, metropolitan area networks (MANs), and/or other types of networks that enable communication between the session-sender 110 and the session-reflector 130.

The session-sender 110 may be in a measurement session with the session-reflector 130. As used herein, a measurement session refers to a bidirectional packet flow between a particular session-sender 110 and a particular session-reflector 130 for a time duration. In the context of an active measurement protocol, the session-sender 110 is an entity that generates and sends test packets to a session-reflector 130. The session-reflector 130 is an entity that generates and sends reflected test packets to a session-sender 110 in response to receiving a test packet from the session-sender 110. In an embodiment, the session-sender 110 is a simple two-way active measurement protocol (STAMP) session-sender and the session-reflector 130 is a STAMP session-reflector. In such an embodiment, the session-sender 110 and the session-reflector 130 may implement STAMP or a variation/extension thereof (e.g., to support the generation of asymmetric network traffic, as described herein).

In an embodiment, the session-sender 110 generates a test packet 150 that includes information regarding the set of reflected test packets 160 that the session-reflector 130 is to send to the session-sender 110. This information included may referred to herein as reflected test packet control information. The reflected test packet control information may indicate the number of reflected test packets 160 to send and a time interval to use between consecutive reflected test packets 160 (e.g., if the session-reflector 130 is to send more than one reflected test packet 160). Additionally or alternatively, the reflected test packet control information may indicate the length of each reflected test packet 160.

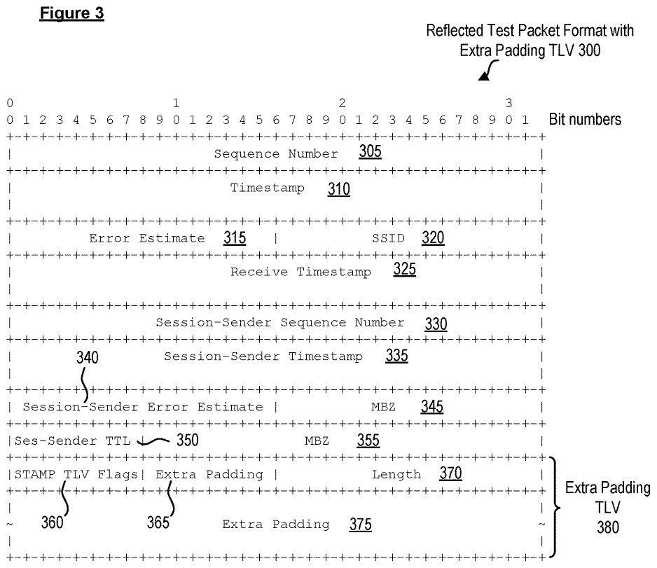

In an embodiment, the reflected test packet control information indicates the time interval to use between consecutive reflected test packets 160 using units of nanoseconds. Those skilled in the relevant art will appreciate that other units of time (e.g., milliseconds) can be used for this purpose. In an embodiment, the reflected test packet control information indicates the length of each reflected test packet 160 using units of octets. Those skilled in the relevant art will appreciate that other units of length (e.g., bits) can be used for this purpose. An example test packet format is shown in FIG. 3 and described later in this disclosure with reference thereto.

Once the session-sender 110 generates the test packet 150, the session-sender 110 may send the generated test packet 150 to the session-reflector 130. In an embodiment, the session-sender 110 sends the test packet 150 to the session-reflector 130 over a user datagram protocol (UDP) connection.

Responsive to receiving the test packet 150 from the session-sender 110, the session-reflector 130 may generate and send one or more reflected test packets 160 back to the session-sender 110 in accordance with the reflected test packet control information that was included in the test packet 150. For example, in the example shown in the diagram, the reflected test packet control information included in the test packet 150 indicates that the session-reflector 130 is to send n reflected test packets 160 using a time interval of x nanoseconds between consecutive reflected test packets 160, and that the length of each reflected test packet 160 is to be y octets. As such, responsive to receiving the test packet 150, the session-reflector 130 may generate and send n reflected test packets 160 to the session-sender 110 using a time interval of x nanoseconds between consecutive reflected test packets, with each reflected test packet 160 having a length of y octets. It should be noted that the number of reflected test packets 160 indicated in the reflected test packet control information may be greater than one and/or the length indicated in the reflected test packet control information may be different from the length of the test packet 150, which allows for generating asymmetric network traffic that can more accurately simulate real network traffic behavior. In an embodiment, the session-reflector 130 sends the reflected test packets 160 to the session-sender 110 over a UDP connection.

In an embodiment, each of the reflected test packets 160 includes a copy of the sequence number included in the test packet 150 and/or a copy of the timestamp included in the test packet 150 (e.g., the timestamp indicating the time at which the test packet 150 was sent by the session-sender 110 to the session-reflector 130).

In an embodiment, each of the reflected test packets 160 includes a different timestamp indicating the time at which the reflected test packet is being sent from the session-reflector 130. In an embodiment, each of the reflected test packets 160 includes a different sequence number indicating an order of the reflected test packet relative to other reflected test packets 160. In an embodiment, each of the reflected test packets 160 includes an extra padding TLV field (or other type of padding) to make the length of the reflected test packet match the length indicated in the reflected test packet control information. An example reflected test packet format is shown in FIG. 3 and described later in this disclosure with reference thereto.

Upon receiving one or more of the reflected test packets 160 from the session-reflector 130, the session-sender 110 may determine one or more network performance metrics based on analyzing the received reflected test packets 160 (e.g., based on the contents of the reflected test packets 160 (e.g., the sequence number included in a reflected test packet, the timestamp included in a reflected test packet, etc.), other information related to the reflected test packets 160 (e.g., the time at which the session-sender 110 received a reflected test packet), and/or the absence of one or more of the reflected test packets). By way of example, the one or more network performance metrics may include a packet loss metric, a packet delay metric, a packet duplication metric, and/or an out-ot-order delivery metric. Those of ordinary skill in the relevant art will appreciate that other types of network performance metrics can be determined based on analyzing the received reflected test packets 160.

An advantage of embodiments disclosed herein is that they provide a way to generate asymmetric network traffic during a measurement session of an active measurement protocol such as STAMP. Also, embodiments provide fine-grained control over the behavior of a session-reflector 130 with respect to how it responds to a test packet (e.g., control over the number and length of reflected test packets 160 that the session-reflector 130 sends to the session-sender 110 in response to a given test packet 150). As a result, embodiments can be used to more accurately simulate real network traffic behavior during a measurement session, which in turn allows for determining/calculating more relevant network performance measurements.

For sake of simplicity, the environment is shown in the diagram as including a single session-sender 110 and a single session-reflector 130. However, those skilled in the relevant art will appreciate that the environment can include additional session-senders 110 and/or additional session-reflectors 130. Also, those skilled in the relevant art will appreciate that a single session-sender 110 can be in a measurement session with multiple session-reflectors 130. Similarly, those skilled in the relevant art will appreciate that multiple session-senders 110 can be in a measurement session with the same session-reflector 130. Also, it should be appreciated that a given network device may function as a session-sender 110 in some measurement sessions and function as a session-reflector 130 in other measurement sessions.

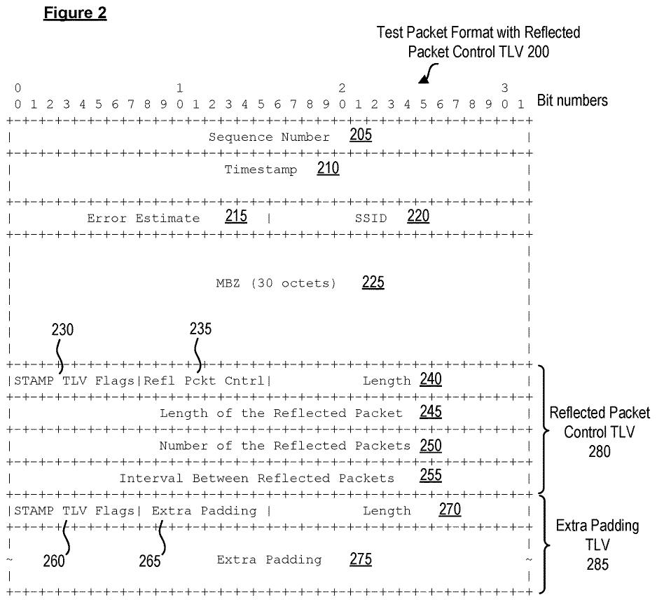

In an embodiment, the test packet 150 includes a special TLV field (referred to herein as a “reflected packet control TLV” field) that includes the reflected test packet control information. An example test packet format that includes a reflected packet control TLV is shown in FIG. 2 and described in further detail herein below with reference thereto.

FIG. 2 is a diagram showing a test packet format with a reflected packet control TLV, according to some embodiments.

As shown in the diagram, the test packet format 200 includes a sequence number field 205, a timestamp field 210, an error estimate field 215, a SSID (session identifier) field 220, a MBZ (must-be-zero) field 225, a reflected packet control TLV field 280, and an extra padding TLV field 285 (the extra padding TLV field 285 may be optional and used to adjust the length of test packets sent by a session-sender to a session-reflector).

The sequence number field 205 may be used to indicate a sequence number that indicates an order of the test packet relative to other packets. In an embodiment, the sequence number field 205 has a length of four octets. In an embodiment, the sequence number starts with a value of zero and is incremented by one with each transmitted packet.

The timestamp field 210 may be used to indicate the time at which the test packet is being sent. In an embodiment, the time stamp field 210 has a length of eight octets. In an embodiment, the time is indicated in the timestamp field 210 using a Network Time Protocol (NTP) version 4 64-bit timestamp format. In an embodiment, the time is indicated in the timestamp field 210 using a IEEE 1588v 2 Precision Time Protocol (PTP) truncated 64-bit timestamp format.

The error estimate field 215 may be used to indicate an estimate of the error and synchronization. In an embodiment, the error estimate field 215 has a length of two octets. The error estimate field 315 may be applicable to the time indicated in the timestamp field 210.

The SSID field 220 may be used to indicate a session ID for the measurement session. In an embodiment, the SSID field 220 has a length of two octets.

The MBZ field 225 may be a field that must be all zeroed on the transmission (and ignored upon receipt). In an embodiment, the MBZ field 225 has a length of 30 octets.

As shown in the diagram, the reflected packet control TLV field 280 includes a STAMP TLV flags field 230, a reflected packet control type field 235, a length field 240, a length of the reflected packet field 245, a number of the reflected packets field 250, and an interval between reflected packets field 255.

The STAMP TLV flags field 230 may be used to indicate various flags related to the reflected packet control TL V field 280 (e.g., similar to the STAMP TLV flags described in RFC 8972). In an embodiment, the STAMP TLV flags field 230 has a length of one octet.

The reflected packet control type field 235 may be used to indicate that the TLV is a reflected packet control type TLV. In an embodiment, the reflected packet control type field 235 includes a value of 10 or 11 to indicate that the TLV is a reflected packet control type TLV (but other values can be used for this purpose so long as the session-sender and the session-reflector agree on using the same value).

The length field 240 may be used to indicate the length of the value field (e.g., the combined length of fields 245, 250, and 255). In an embodiment, the length field 240 indicates the length of the value field using units of octets. In an embodiment, length of the reflected packet control TL V field 280 is fixed/static. The length indicated in the length field 240 may be used for performing a sanity check for the reflected packet control TLV field 280 (e.g., to make sure that the value portion of the reflected packet control TL V field 280 has the expected length).

The length of the reflected packet field 245 may be used to indicate the length of reflected test packets to be sent by the session-reflector. In an embodiment, the length of reflected test packets to be sent by the session-reflector is indicated in the length of the reflected packet field 245 using units of octets. In an embodiment, the length of the reflected packet field 245 has a length of four octets.

The number of the reflected packets field 250 may be used to indicate the number of reflected test packets that the session-reflector is to send to the session-sender as a response to the test packet. In an embodiment, the number of reflected test packets that the session-reflector is to send to the session-sender indicated in the number of the reflected packets field 250 can be greater than one. In an embodiment, the number of the reflected packet field 250 has a length of four octets.

The interval between reflected packets field 255 may be used to indicate the time interval that the session-reflector is to use between consecutive reflected test packets (when sending multiple successive reflected test packets). In an embodiment, the time interval is indicated in the interval between reflected packets field 255 using units of nanoseconds. However, it should be appreciated that alternative embodiments can use a different unit of time (e.g., milliseconds). In an embodiment, the interval between reflected packets field 255 has a length of four octets.

The length of the reflected packet field 245, the number of the reflected packets field 250, and/or the interval between reflected packets field 255 may be used to convey reflected test packet control information.

As shown in the diagram, the extra padding TLV field 285 includes a STAMP TLV flags field 260, an extra padding type field 265, a length field 270, and an extra padding field 275.

The STAMP TLV flags field 260 may be used to indicate various flags related to the extra padding TLV field 285 (e.g., similar to the STAMP TLV flags described in RFC 8972). In an embodiment, the STAMP TLV flags field 260 has a length of one octet.

The extra padding type field 265 may be used to indicate that the TLV is an extra padding type TLV. In an embodiment, the extra padding type field 265 includes a value of 1 to indicate that the TLV is an extra padding type TLV.

The length field 270 may be used to indicate the length of the value field (e.g., the length of the extra padding field 275). In an embodiment, the length field 270 indicates the length of the value field using units of octets.

The extra padding field 275 may be used for padding purposes (e.g., to adjust the overall length of the test packet). In an embodiment, the extra padding field 275 is filled with a sequence of pseudorandom numbers. In an embodiment, the extra padding field 275 is filled with all zeroes.

Although a specific test packet format is shown in the diagram, it should be appreciated that other embodiments can use a different format. Thus, the test packet format shown in the diagram should be regarded as illustrative rather than limiting.

In an embodiment, a reflected test packet 160 includes an extra padding TLV field that is used to pad the reflected test packet 160 (e.g., to make the length of the reflected test packet 160 match the length indicated in the reflected test packet control information). An example reflected test packet format that includes an extra padding TLV is shown in FIG. 3 and described in further detail herein below with reference thereto.

FIG. 3 is a diagram showing a reflected test packet control TLV field format, according to some embodiments.

As shown in the diagram, the reflected test packet format 300 includes a sequence number field 305, a timestamp field 310, an error estimate field 315, a SSID field 320, a receive timestamp field 325, a session-sender sequence number field 330, a session-sender timestamp field 335, a session-sender error estimate field 340, a MBZ field 345, a session-sender time-to-live (TTL) field 350 (abbreviated in the diagram as “Ses-Sender TTL”), a MBZ field 355, and an extra padding TLV field 380.

The sequence number field 305 may be used to indicate a sequence number that indicates an order of the reflected test packet relative to other packets. In an embodiment, the sequence number field 305 has a length of four octets.

The timestamp field 310 may be used to indicate the time at which the reflected test packet is being sent. In an embodiment, the time stamp field 310 has a length of eight octets. In an embodiment, the time is indicated in the timestamp field 310 using a Network Time Protocol (NTP) version 4 64-bit timestamp format. In an embodiment, the time is indicated in the timestamp field 310 using a IEEE 1588v 2 Precision Time Protocol (PTP) truncated 64-bit timestamp format.

The error estimate field 315 may be used to indicate an estimate of the error and synchronization with regard to time. In an embodiment, the error estimate field 215 has a length of two octets. In an embodiment, the error estimate field 315 is applicable to the time indicated in the timestamp field 310 and/or the time indicated in the receive timestamp field 325.

The SSID field 320 may be used to indicate a session ID for the measurement session. In an embodiment, the SSID field 320 has a length of two octets.

The receive timestamp field 325 may be used to indicate the time at which a test packet was received by the session-reflector. In an embodiment, the receive timestamp field 325 has a length of eight octets.

The session-sender sequence number field 330 may be used to indicate the sequence number indicated in a test packet sent by the session-sender (a copy of the sequence number indicated in the test packet that caused the reflected test packet to be generated). In an embodiment, the session-sender sequence number field 330 has a length of four octets.

The session-sender timestamp field 335 may be used to indicate the timestamp indicated in a test packet sent by the session-sender (a copy of the timestamp indicated in the test packet that caused the reflected test packet to be generated). In an embodiment, the session-sender timestamp field 335 has a length of eight octets.

The session-sender error estimate field 340 may be used to indicate the error estimate indicated in the test packet sent by the sessions-sender (a copy of the error estimate indicated in the test packet that caused the reflected test packet to be generated). In an embodiment, the session-sender error estimate field 340 has a length of two octets.

The MBZ field 345 may be a field that must be all zeroed on the transmission (and ignored upon receipt). The MBZ fields (MBZ field 345 and MBZ field 355) may be used to achieve alignment of fields within the reflected test packet on a four-octet boundary.

The session-sender TTL field 350 may be used to indicate the TTL indicated in the Internet Protocol version 4 (IPv4) header of a test packet sent by the session-sender or the hop limit indicated in the Internet Protocol version 6 (IPv6) header of a test packet sent by the session-sender.

The MBZ field 355 may be a field that must be all zeroed on the transmission (and ignored upon receipt). As mentioned above, the MBZ fields (MBZ field 345 and MBZ field 355) may be used to achieve alignment of fields within the reflected test packet on a four-octet boundary.

As shown in the diagram, the extra padding TLV 380 field includes a STAMP TLV flags field 360, an extra padding type field 365, a length field 370, and an extra padding field 375.

The STAMP TLV flags field 360 may be used to indicate various flags related to the extra padding TLV field 380 (e.g., similar to the STAMP TLV flags described in RFC 8972). In an embodiment, the STAMP TLV flags field 360 has a length of one octet.

The extra padding type field 365 may be used to indicate that the TLV is an extra padding type TLV. In an embodiment, the extra padding type field 265 includes a value of 1 to indicate that the TLV is an extra padding type TLV.

The length field 370 may be used to indicate the length of the value field (e.g., the length of the extra padding field 375). In an embodiment, the length field 370 indicates the length of the value field using units of octets.

The extra padding field 275 may be used for padding purposes (e.g., to adjust the overall length of the test packet so that it matches the length indicated in the reflected test packet control information, as described elsewhere herein). In an embodiment, the extra padding field 275 is filled with a sequence of pseudorandom numbers. In an embodiment, the extra padding field 275 is filled with all zeroes.

Although a specific reflected test packet format is shown in the diagram, it should be appreciated that other embodiments can use a different format. Thus, the reflected test packet format shown in the diagram should be regarded as illustrative rather than limiting.

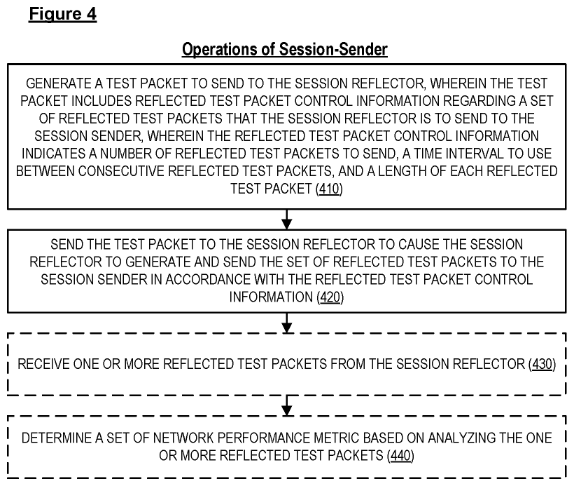

FIG. 4 is a flow diagram of a process performed by a session-sender in a measurement session with a session-reflector for simulating asymmetric network traffic, according to some embodiments.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

While the flow diagrams in the figures show a particular order of operations performed by certain embodiments, it should be understood that such order is provided by way of example (e.g., alternative embodiments may perform the operations in a different order, combine certain operations, overlap certain operations, etc.).

At operation 410, the session-sender generates a test packet to send to the session-reflector, wherein the test packet includes reflected test packet control information regarding a set of reflected test packets that the session-reflector is to send to the session-sender. The reflected test packet control information indicates a number of reflected test packets to send, a time interval to use between consecutive reflected test packets, and a length of each reflected test packet. In an embodiment, the reflected test packet control information indicates the length of each reflected test packet using units of octets (but other embodiments may use a different unit of length). In an embodiment, the length of each reflected test packet indicated in the reflected test packet control information is different from a length of the test packet. In an embodiment, the reflected test packet control information indicates the time interval to use between consecutive reflected test packets using units of nanoseconds or milliseconds (but other embodiments may use a different unit of time). In an embodiment, the number of reflected test packets to send indicated in the reflected test packet control information is greater than one (but it should be appreciated that the number of reflected test packets to send can also be set to one in some cases).

In an embodiment, the test packet is a STAMP test packet. In an embodiment, the test packet includes a TLV field (e.g., a reflected packet control TLV), wherein the TLV field includes the reflected test packet control information.

At operation 420, the session-sender sends the test packet to the session-reflector to cause the session-reflector to generate and send the set of reflected test packets to the session-sender in accordance with the reflected test packet control information. In an embodiment, the test packet is sent over a UDP connection.

In an embodiment, at operation 430, the session-sender receives one or more reflected test packets from the session reflector.

In an embodiment, at operation 440, the session-sender determines a set of network performance metrics based on analyzing the one or more reflected test packets. In an embodiment, the set of network performance metrics includes one or more of: a packet loss metric, a packet delay metric, a packet duplication metric, and an out-ot-order delivery metric.

In an embodiment, the reflected test packet control information indicates the number of reflected test packets to send, but does not indicate the length of each reflected test packet. In such an embodiment, it may be implied that length of each reflected test packet should be the same as the length of the test packet. In an embodiment, the reflected test packet control information indicates the number of reflected test packets to send, but does not indicate the time interval to use between consecutive reflected test packets. In such an embodiment, the session-reflector may determine the time interval to use between consecutive reflected test packets (e.g., the session-reflector may be preconfigured to use a certain time interval). In an embodiment, the reflected test packet control information indicates the length of the reflected test packet, but does not indicate the number of reflected test packets to send or the time interval to use between consecutive reflected test packets. In such an embodiment, it may be implied that the number of reflected test packets to send is one.

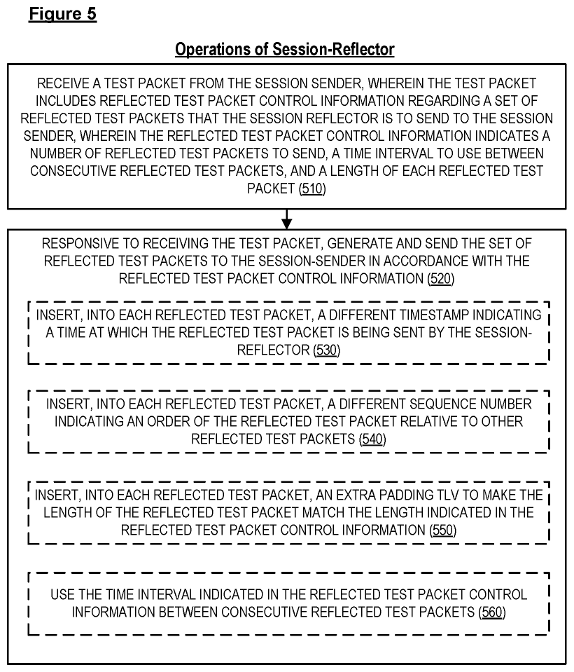

FIG. 5 is a flow diagram of a process performed by a session-reflector in a measurement session with a session-sender for simulating asymmetric network traffic, according to some embodiments.

At operation 510, the session-reflector receives a test packet from the session-sender, wherein the test packet includes reflected test packet control information regarding a set of reflected test packets that the session-reflector is to send to the session-sender. The reflected test packet control information indicates a number of reflected test packets to send, a time interval to use between consecutive reflected test packets, and a length of each reflected test packet. In an embodiment, the reflected test packet control information indicates the length of each reflected test packet using units of octets (but other embodiments may use of different unit of length). In an embodiment, the length of each reflected test packet indicated in the reflected test packet control information is different from a length of the test packet. In an embodiment, the reflected test packet control information indicates the time interval to use between consecutive reflected test packets units of nanoseconds or milliseconds (but other embodiments may use a different unit of time). In an embodiment, the number of reflected test packets to send indicated in the reflected test packet control information is greater than one (but it should be appreciated that the number of reflected test packets to send can be set to one in some cases).

In an embodiment, the test packet is a STAMP test packet. In an embodiment, the test packet includes a TLV field (e.g., a reflected packet control TLV), wherein the TLV field includes the reflected test packet control information. In an embodiment, the test packets is sent over a UDP connection.

At operation 520, responsive to receiving the test packet, the session-reflector generates and sends the set of reflected test packets to the session-sender in accordance with the reflected test packet control information. In an embodiment, the set of reflected test packets are sent over a UDP connection.

In an embodiment, generating and sending the set of reflected test packets to the session-sender involves one or more of operations 530-560.

At operation 530, the session-reflector inserts, into each reflected test packet, a different timestamp indicating a time at which the reflected test packet is being sent by the session-reflector.

At operation 540, the session-reflector inserts, into each reflected test packet, a different sequence number indicating an order of reflected test packet relative to other reflected test packets.

At operation 550, the session-reflector inserts, into each reflected test packet, an extra padding TLV (or other type of padding) to make the length of the reflected test packet match the length indicated in the reflected test packet control information.

At operation 560, the session-reflector uses the time interval indicated in the reflected test packet control information between consecutive reflected test packets.

In an embodiment, the reflected test packet control information indicates the number of reflected test packets to send, but does not indicate the length of each reflected test packet. In such an embodiment, the session-reflector may imply that the length of each reflected test packet should be the same as the length of the test packet. In an embodiment, the reflected test packet control information indicates the number of reflected test packets to send, but does not indicate the time interval to use between consecutive reflected test packets. In such an embodiment, the session-reflector may determine the time interval to use between consecutive reflected test packets (e.g., the session-reflector may be preconfigured to use a certain time interval). In an embodiment, the reflected test packet control information indicates the length of the reflected test packet, but does not indicate the number of reflected test packets to send or the time interval to use between consecutive reflected test packets. In such an embodiment, the session-reflector may imply that the number of reflected test packets to send is one.

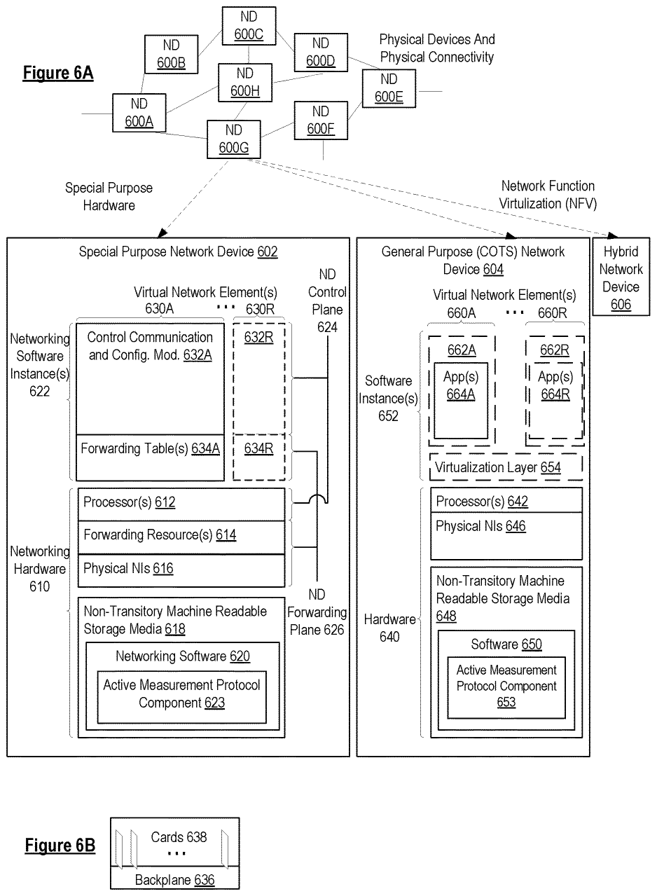

FIG. 6A illustrates connectivity between network devices (NDs) within an exemplary network, as well as three exemplary implementations of the NDs, according to some embodiments. FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated circuits (ASICs) and a special-purpose operating system (OS); and 2) a general purpose network device 604 that uses common off-the-shelf (COTS) processors and a standard OS.

The special-purpose network device 602 includes networking hardware 610 comprising a set of one or more processor(s) 612, forwarding resource(s) 614 (which typically include one or more ASICs and/or network processors), and physical network interfaces (NIs) 616 (through which network connections are made, such as those shown by the connectivity between NDs 600A-H), as well as non-transitory machine readable storage media 618 having stored therein networking software 620. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A).

The special-purpose network device 602 is often physically and/or logically considered to include: 1) a ND control plane 624 (sometimes referred to as a control plane) comprising the processor(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the processor(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

In an embodiment, software 620 includes code such as active measurement protocol component 623, which when executed by networking hardware 610, causes the special-purpose network device 602 to perform operations of one or more embodiments disclosed herein (e.g., to simulate asymmetrical network traffic during a measurement session of an active measurement protocol).

FIG. 6B illustrates an exemplary way to implement the special-purpose network device 602 according to some embodiments. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL) / Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general purpose network device 604 includes hardware 640 comprising a set of one or more processor(s) 642 (which are often COTS processors) and physical NIs 646, as well as non-transitory machine readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor-the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the physical NI(s) 646, as well as optionally between the instances 662A-R; in addition, this virtual switch may enforce network isolation between the VNEs 660A-R that by policy are not permitted to communicate with each other (e.g., by honoring virtual local area networks (VLANs)).

In an embodiment, software 650 includes code such as active measurement protocol component 653, which when executed by hardware 640, causes the general purpose network device 604 to perform operations of one or more embodiments disclosed herein (e.g., (e.g., to simulate asymmetrical network traffic during a measurement session of an active measurement protocol).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

1. A method performed by a network device functioning as a session-sender in a measurement session with a session-reflector to simulate asymmetric network traffic, the method comprising:
generating a test packet to send to the session-reflector, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet; and
sending the test packet to the session-reflector to cause the session-reflector to generate and send the set of reflected test packets to the session-sender in accordance with the reflected test packet control information.

2. (canceled)

3. The method of claim 1, wherein the length of each reflected test packet indicated in the reflected test packet control information is different from a length of the test packet.

4. (canceled)

5. The method of claim 1, wherein the number of reflected test packets to send indicated in the reflected test packet control information is greater than one.

6. (canceled)

7. The method of claim 1, further comprising:
receiving one or more reflected test packets from the session-reflector; and
determining a set of network performance metrics based on analyzing the one or more reflected test packets.

8. The method of claim 7, wherein the set of network performance metrics includes one or more of: a packet loss metric, a packet delay metric, a packet duplication metric, and an out-ot-order delivery metric.

9. (canceled)

10. (canceled)

11. A method performed by a network device functioning as a session-reflector in a measurement session with a session-sender to simulate asymmetric network traffic, the method comprising:
receiving a test packet from the session-sender, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet; and
responsive to receiving the test packet, generating and sending the set of reflected test packets to the session-sender in accordance with the reflected test packet control information.

12. (canceled)

13. The method of claim 11, wherein the length of each reflected test packet indicated in the reflected test packet control information is different from a length of the test packet.

14. (canceled)

15. The method of claim 11, wherein the number of reflected test packets to send indicated in the reflected test packet control information is greater than one.

16. (canceled)

17. (canceled)

18. (canceled)

19. (canceled)

20. The method of claim 11, wherein each reflected test packet in the set of reflected test packets includes a different sequence number indicating an order of the reflected test packet relative to other reflected test packets.

21. The method of claim 11, wherein each reflected test packet in the set of reflected test packets includes an extra padding type-length-value (TLV) field to make the length of the reflected test packet match the length of each reflected test packet indicated in the reflected test packet control information.

22. A non-transitory machine-readable medium having instructions stored therein, which when executed by a network device implementing a session-sender that is in a measurement session with a session-reflector, causes the session-sender to perform operations comprising:
generating a test packet to send to the session-reflector, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet; and
sending the test packet to the session-reflector to cause the session-reflector to generate and send the set of reflected test packets to the session-sender in accordance with the reflected test packet control information.

23. A non-transitory machine-readable medium having instructions stored therein, which when executed by a network device implementing a session-reflector that is in a measurement session with a session-sender, causes the session-reflector to perform operations comprising:
receiving a test packet from the session-sender, wherein the test packet includes reflected test packet control information regarding a set of reflected test packets that the session-reflector is to send to the session-sender, wherein the reflected test packet control information indicates a number of reflected test packets to send, a time interval to use between consecutive reflected test packets, and a length of each reflected test packet; and
responsive to receiving the test packet, generating and sending the set of reflected test packets to the session-sender in accordance with the reflected test packet control information.

24. (canceled)

25. (canceled)

26. The non-transitory machine-readable medium of claim 22, wherein the length of each reflected test packet indicated in the reflected test packet control information is different from a length of the test packet.

27. The non-transitory machine-readable medium of claim 22, wherein the number of reflected test packets to send indicated in the reflected test packet control information is greater than one.

28. The non-transitory machine-readable medium of claim 22, wherein the operations further comprise:
receiving one or more reflected test packets from the session-reflector; and
determining a set of network performance metrics based on analyzing the one or more reflected test packets.

29. The non-transitory machine-readable medium of claim 28, wherein the set of network performance metrics includes one or more of: a packet loss metric, a packet delay metric, a packet duplication metric, and an out-ot-order delivery metric.

30. The non-transitory machine-readable medium of claim 23, wherein the length of each reflected test packet indicated in the reflected test packet control information is different from a length of the test packet.

31. The non-transitory machine-readable medium of claim 23, wherein the number of reflected test packets to send indicated in the reflected test packet control information is greater than one.

32. The non-transitory machine-readable medium of claim 23, wherein each reflected test packet in the set of reflected test packets includes a different sequence number indicating an order of the reflected test packet relative to other reflected test packets.

33. The non-transitory machine-readable medium of claim 23, wherein each reflected test packet in the set of reflected test packets includes an extra padding type-length-value (TLV) field to make the length of the reflected test packet match the length of each reflected test packet indicated in the reflected test packet control information.
